(19) United States
(12) Patent Application Publication
(10) Pub. No.: US 2005/0168090 A1
(43) Pub. Date: Aug. 4, 2005

(54) High power two speed electric motor

(76) Inventor: Len Charles Gould, Brampton (CA)

Correspondence Address: Mr. Len C. Gould, 43 Copeland Road, Brampton, L6Y 2S5, CA

(21) Appl. No.: 10/768,120

(22) Filed: Feb. 2, 2004

(51) Int. Cl. H02K 17/00; H02K 19/00

(52) U.S. Cl. 310/159; 310/166; 310/162

(57) ABSTRACT

This invention is a new dynamo electric machine of the alternating current type which provides for the entire stator winding to operate as an alternating current induction machine for relatively shorter periods of very high torque output operation, then provides for a portion of the stator winding to operate as a direct current exciter field winding while the balance of the stator operates as the armature windings of a high efficiency salient pole alternating current synchronous machine. The said machine or any electrical machine is further made more compact for a specific rate of output by providing stator winding insulation of an insulating material which provides for very high temperature operation and/or relatively high volume circulation of coolant throughout the porous winding insulation and potentially operates successfully at much higher temperatures than typical insulation systems. Also provided is a novel means of rotatably supporting a rotor of a dynamo electrical machine.

### FIELD OF THE INVENTION

This invention applies to dynamo electrical machines of either pure or mixed synchronous and inductive operation which require very high power density in the windings. It also applies to any electrical machine which can benefit from an advanced insulating and cooling system for the windings.

### BACKGROUND OF THE INVENTION

It is known to employ a modified lundel or claw pole construction to create a synchronous machine in which the exciter is created from pole pieces as projecting teeth interleaved in fixed position mechanically between the projecting teeth of the main AC stator core and projecting at the face of the gap between the stator and the rotor, Magnetic pole pieces are then embedded into a nonmagnetic rotor structure to alternately make and break a magnetic circuit between exciter stator teeth and armature stator teeth.

Nishimura in U.S. Pat. No. 6,495,941 teaches the construction of a generator in this manner. Nishimura only considers operating the resulting machine as a synchronous machine and makes no provision to excite the stator as an inductive machine or to modify the rotor so that might make sense. Although this design works well as a generator, as a motor it suffers from low accelerating torque and low power density, shortcomings which the present invention is designed to overcome.

Dale L. Cotton in U.S. Pat. No. 4,471,247 teaches the use of relatively high density PPS foam as ground insulation (that insulation in a magnetic coil assembly which separates the external surfaces of the pre-assembled electrical coil from the iron or steel pole piece on which it is mounted). No consideration is given to the possibility of then using the pores of the foam as coolant passages, likely because at the high density of the recommended foam the cells will be closed and there wouldn't be any such passages.

Emil D. Jarczynski et al. in U.S. Pat. No. 5,633,543 teach the use of variably sized coolant ducts passing radially through the stator laminates of a large power generator machine to the purpose of improving the cooling of the stator windings and iron. No consideration is given to possibly allowing all or part of this coolant to flow through the pores of a permeable insulating material surrounding the winding conductors within the slots of the stator.

Jose-Pierre Paroz in U.S. Pat. No. 5,717,267 teaches the replacement of insulating resin impregnated foam electrical insulation commonly used only in the stator winding head, or coolant header connections, of water-cooled electrical machines with an alternate configuration. In no part is the use of the foam to itself provide coolant passages within the stator considered.

Shin Kusase et al in U.S. Pat. No. 5,955,804 teach the insertion of openings between conductors at the coil ends of an automobile alternator to facilitate passage of cooling air over the coil ends to improve cooling of the coil conductors. No consideration is given to the use of a spacing material to enforce this separation except for reference to a flexible heat conductive insulation member which might be inserted between the coil ends of a winding and attached to the stator body to conduct heat away from the winding conductor ends This invention also heavily depends on the self-support of the relatively heavy conductors in a small low-voltage alternator and would not be very useful in a larger or higher voltage alternator where coil end distances and conductor sizes would require specific support to enable such separation.

Micheal Liebman in U.S. Pat. No. 6,262,503 teaches the insertion of openings created by a thermally conductive material in at least part of the coils of a winding. The inserted material may be formed into combs which are then connected at their outermost end to a coolant circulation system to remove heat from the conductors of the coil.

Gaku Hayase et al. in U.S. Pat. No. 6,577,027 teach the insertion of insulating cooling blocks between the layers of a disc winding in a large power transformer but do not anticipate that coolant will flow through the said insulating blocks, only around them.

None of the prior art provides a machine which can operate in either inductive mode or synchronous mode without any active windings on the rotor, without compromising performance in either mode and without concern for thermal limits until the melting temperatures of the stator conductors or magnetic materials are approached, or alternatively provides sufficiently effective coolant circulation that electrical specifications can be greatly increased for a given size of machine.

### SUMMARY OF THE INVENTION

A first object of the present invention is to provide a dynamo electrical machine which can operate as either an inductive machine or as a synchronous machine without any externally powered windings on the rotor.

A second object of the present invention is to provide a means of constructing the windings of any electrical machine so that no organic or plastic winding insulation materials are used in the construction, thus allowing the machine to operate reliably at very high temperatures without damaging the winding insulation.

A further object of the present invention is to provide a means of constructing the windings of any electrical machine so that if organic or plastic winding insulation materials are used in the construction, coolant circulation paths are provided which allow the machine to operate reliably at very high amperages without damaging the winding insulation.

A further object is to provide a novel method of combining the cooling means with a bearing lubricant means in a dynamo electrical machine.

The first preferred embodiment of the present invention is a dynamo electric machine constructed in the lundel or claw pole fashion but, rather than having the extended pole pieces or claws and DC winding of the exciter rotating on a shaft at the centre of a fixed wound stator, the exciter is created from pole pieces as projecting teeth interleaved in fixed position mechanically between the projecting teeth of the main AC stator core and projecting at the face. A standard 3 phase AC motor winding is wound onto every second projecting tooth of the stator armature and connected in Wye to a dedicated variable frequency drive circuit. The remaining half of the stator projecting teeth are then wound to be electrically identical to the previous winding and connected in Wye to their own dedicated variable frequency drive circuit, resulting in a winding which when excited with a three phase alternating current which is very nearly or fully in step with the main winding, will duplicate the main winding's magnetic operation exactly. However, when the same winding has an auxiliary direct current driver circuit connected to the Wye point and is excited with direct current of the correct polarity by its primary drivers it will produce the exciter magnetic poles required to operate the machine as a synchronous machine. In this embodiment the number of pole pieces in the rotor is equal to [stator tooth count]×[main winding phase count+1]/(main winding phase count). This design provides for a reduction in total magnetic material mass for an equivalent torque capability and a high power density on an angular arc or gap area basis for an equal tooth length when compared to a current standard electric motor.

The first preferred embodiment of the invention provides three different means of constructing a rotor suitable for operation as either an induction machine or a synchronous machine.

The first such means provides a second set of pole pieces united into a single element by a nonmagnetic material and which is placed against the back faces of the main pole pieces of the rotor, being the faces radially furthest from the stator. One or more actuators are installed to provide the capability to slide the second set of pole peices between a first position and a second position. In the first position the secondary pole pieces provide a magnetic path between the main rotor pole pieces, enabling the rotor to operate as an induction machine rotor. In the second position the secondary pole pieces do not bridge the gap between the main rotor pole pieces, leaving the rotor suitable for operation as a synchronous machine rotor. Optionally the actuators may be replaced with short springs which tend to counteract the movement induced into the slideable parts by the rotating magnetic field of the stator. When the stator is operating as an induction machine the powerful magnetic field overcomes the springs, allowing the secondary pieces to move to a position where they bridge the gap between rotor main pole pieces. When the stator is operating as a synchronous machine at lower power the springs return the secondary pieces to their original position where they do not bridge the gap between the rotor main pole pieces

The second such means which is suitable for use only on a machine having the rotor surrounding the stator externally such as may be used to construct a wheel motor, provides a second set of pole pieces individually hinged to the backs of each of the rotor pole pieces. The entire rotor is surrounded with a spring means which forces the hinged pieces to lay flat against the backs of the main rotor pole pieces when at rest, closing the magnetic circuit between adjacent main rotor pole pieces and leaving the rotor suited to operation as an induction machine rotor. When the rotor rotation rate exceeds a designed rate then centrifugal force overcomes the springs causing the hinged secondary pole pieces to move away from the backs of the main rotor pole pieces, breaking the magnetic circuit between pole pieces and leaving the rotor suited to operation as a synchronous machine.

The third such means provides a rotor constructed of laminates which surround the axial core of the machine in a single piece, with salient teeth projecting toward the stator from a main rotor core. The salient teeth are surrounded by an electrically conductive nonmagnetic material. During periods of operation of the stator as an inductive machine the magnetic lines of force in the rotor are forced to follow a path over the inductive conductors and through the rotor body material to a stator pole of suitable polarity. During periods of operation of the stator as a synchronous machine the magnetic lines of force preferrably follow the much shorter path through just the faces of the salient teeth to the nearest neighbouring exciter pole of appropriate polarity. In this means the relative height of the salient teeth and inductive conductors of the rotor is adjusted to alter machine performance preferentially toward inductive machine power and efficiency or synchronous machine power and efficiency.

The second and third objectives are met in the first preferred embodiment of the invention by having the individual conductor turns of the stator coil windings separated by an electrically nonconductive open cell foam material which has been preformed to fit over the salient teeth of the stator during or after the winding operation and which incorporates grooves which accomodate the conductor. As an example, if this open cell foam material is fabricated from silicon carbide and the copper winding connections are made by a welding process such as thermite welding or brazing then the entire stator has no thermal limit to its operating temperature until the copper conductors approach their melting temperatures near perhaps 800 degress C. The thermal limit of the machine will then be set only by the heating capacity and allowable temperature rise of the rotor poles which can be controlled by fabricating the pole pieces from a very low loss magnetic steel such as is sold by Elna Magnetics. It is calculated that a stator can be manufactured to fit within a standard automible wheel using 19 turns per layer in 5 layers of 16 awg equivalent rectangular copper conductor at 69% slot fill on a stator with 12 main teeth and 12 exciter teeth 211 mm wide and 30 mm in height which will operate quite efficiently in synchronous mode with up to a maximum of 9 KW 360 V 750 Hz AC power and 1 KW DC excitation while generating 1.52 KW heat due to Isup2R losses. The same stator is also capable of operating in induction mode with maximums of 60 KW 360 V 75 Hz AC circuit power plus 40 KW 288 V AC 75 Hz power applied to the exciter poles for a total of 100 KW input resulting in 58.09 KW heat generation due to Isup2R losses in the windings. Assuming the stator weighs 57 kg the resultant temperature rise will be 20.75 degrees C. per 10 second acceleration period, a rate which may not even require auxiliary cooling. For hill climbing or towing etc. it will almost certainly be necessary to provide auxiliary cooling, a task which is greatly simplified due to the open cell nature of the foam insulation separating the windings. A closed circuit of a selected coolant such as filtered air or CO2 is compressed in a small compressor onboard the vehicle, cooled in an air heat exchanger, then allowed to expand into the stator enclosure at a low point. A return line attached to a high point in the stator returns the coolant to the compressor inlet to complete the circuit. An alternative coolant for any purpose is a low viscosity nonconductive oil such as the silicon based oils now used as coolant in most large power transformers. In this case it may be possible to ensure winding temperatures never exceed the damage point of some polymers, which will simplify the manufacturing of the insulating material. For a really high performance application consideration might be given to bathing the stator windings in liquid CO2 supplied from a refrigeration circuit, in which case any rigid open cell foam material can be used as the winding insulation since the temperature should never exceed the damage temperature of even a plastic foam. Of course the ultimate in high performance can be achieved by using a high temperature superconductor for the winding conductors and bathing the entire stator in liquid nitrogen from a refrigeration circuit, provided a superconductor material can be found which is not affected by the intense magnetic fields involved. Of course for uncooled high temperature designs there remains the difficulty of tightly fastening the coil to the stator teeth or within the slots with a system which is also capable of withstanding the design temperature, a problem which can be overcome with silicon carbide foam by fastening the several layer into place with rivets or bolts through openings provided in the stator teeth for the purpose, or with mechanical wedges.

In lower performance applications it may be acceptable to bond a layer of open cell foam onto the surface of a standard PPS or enamel insulated or bare conductor of the type now typically used in motor manufacturing. The resulting conductor is then used to wind the stator. The foam layer then provides a path for coolant to circulate within the winding far more effectively than in typical current solid insulatio impergnated stator windings. If a somewhat compressible foam material is used it can effectively stabilize the conductors within the slots if the slot fill is carefully managed and strong slot wedges are used to compress the foam insulated conductors into the slots. The resulting improved coolling will allow an increase in current rating of the conductors to compensate for any reduced conductor cross section of the winding.

The fourth objective is met in the first preferred embodiment of the invention by having the pressurized coolant which is supplied to the stator of a wheel motor which is constructed according to the above description also act as the lubricant of a bearing which supports the rotor by applying pressurized coolant to the centre of the rotor-stator gap of the dynamo electric machine. If the coolant is a liquid then provision is made to properly communicate it into an appropriate section of the gap between the rotor and the stator. If the coolant is a gas then to facilitate this operation it is necessary to close off the tops of the winding slots which are exposed to the gap leaving only one or more narrow openings at the rotor-stator gap at each slot for the pressurized coolant gas which permeates the open cell foam pores of the winding insulation to flow into the gap between the stator and the rotor. To accomplish this any of several methods may be employed, including but not limited to a) bonding a thin stiff sheet of nonmagnetic material such as stainless steel, ceramic or carbon fiber sheet to the stator tooth faces, or b) sealing the pores of the insulating foam where it is exposed to the gap either during fabrication or after assembly, then polishing the resulting surface to bearing quality. The edges of the rotor-stator gap are then sealed by any well known method such as providing a light contact graphite or ceramic sealing ring, and the coolant pressure within the stator is controlled according to the well known formula for gas bearings which is
Load Force=0.3×Supply Pressure×Loaded Area
or Supply Pressure=Load Force/(0.3×Loaded Area)

Example calculation: For a 50 cm diameter rotor-stator gap 21 cm wide loaded with 600 kg, the required lubricant and coolant gas supply pressure to lubricate the gas bearing would be between 191 and 382 kpa or 28 and 56 psi, depending on the relative pressure differences from top to bottom of the gap which can affect load force. Conveniently this pressure is also in the range of tire inflation pressure for the application so it would be possible to provide to communiate the coolant into or past the rotor into the tire at the bottom and back out at the top of the wheel, to the purpose of controlling pole piece and inductive conductor circuit temperature rises in the rotor as well as tire inflation pressure, a distinct advantage for efficient and safe operation.

### DESCRIPTION OF THE DRAWINGS

In drawings which illustrate embodiments of the invention,

FIG. 1 is a section view of a first preferred embodiment of the invention applied to a wheel motor for a motor vehicle

FIG. 2 is a longitudinal section of the motor of FIG. 1 indicating the connections of the six phase windings and driver exciter waveforms when the motor operates as an induction machine.

FIG. 3 is a power waveform diagram showing 450 electrical degrees of the power applied to the motor of FIG. 1 when it is operating as an induction machine.

FIGS. 4 to 9 show the rotor movement at 60 electrical degree intervals of the motor in FIG. 1 when it is operating as an induction machine through 360 electrical degrees.

FIG. 10 is a longitudinal section of the motor of FIG. 1 indicating the connections of the windings and driver exciter waveforms when the motor operates as a synchronous machine.

FIG. 11 is a power waveform diagram showing 450 electrical degrees of the power applied to the motor of FIG. 1 when it is operating as a synchronous machine.

FIGS. 12 to 17 show the rotor movement at 60 electrical degree intervals of the motor in FIG. 1 when it is operating as a synchronous machine through 360 electrical degrees.

FIG. 18 shows the rotor and stator of a dynamo electrical machine constructed according to the invention and which is capable of operating as either an induction machine or a synchronous machine.

FIGS. 19 and 20 show the rotation of the rotor of FIG. 18 at 120 and 240 electrical degree intervals.

FIG. 21 shows the same rotor and stator from FIG. 18 when excited as a synchronous machine.

FIGS. 22 and 23 show the rotation of the rotor of FIG. 21 at 120 and 240 electrical degree intervals.

FIG. 24 shows a second embodiment of the invention having a single moveable means of opening the magnetic circuit between rotor pole pieces and an actuator which controls the moveable means.

FIG. 25 shows a third embodiment of the invention having a single moveable means of opening the magnetic circuit between rotor pole pieces and a spring which controls the moveable means.

FIG. 26 shows a fourth embodiment of the invention having a large number of moveable means of opening the magnetic circuits between rotor pole pieces and a surrounding spring which controls the large number of moveable means.

FIG. 27 shows a wheel motor constructed according an alternate possible embodiment of the invention having the exciter poles of the stator constructed as extended fingers from a main exciter body mounted to the back of the stator.

FIG. 28 shows a view in partial section of a dynamo electrical machine constructed according to a first preferred embodiment of the invention having the conductors of the stator windings surrounded in an open cell foam material.

FIG. 28b is a detail of a part of the stator windings of the dynamo electrical machine of FIG. 28.

FIG. 29 is a view of the preformed slot winding insulation element which forms the two halves of a coils first layer of windings in the dynamo electrical machine of FIG. 27.

FIG. 30 is a view of the preformed slot winding insulation element which forms the two halves of a coils second layer of windings in the dynamo electrical machine of FIG. 27.

FIG. 31 is a view of one half of the stator outer surface of a dynamo electrical machine constructed according to the invention in which the stator-rotor gap acts a a gas bearing to support the rotor surface during rotation

FIG. 32 is a view of one half of the stator outer surface of a second dynamo electrical machine constructed according to the invention in which the stator-rotor gap acts as a gas bearing to support the rotor surface during rotation and the shape of the stator-rotor gap is modified to allow it to act as an axial thrust bearing as well as a radial load bearing.

FIG. 33 is a cross section view of a conductor coated with a layer of open cell foam material for use in winding an electrical machine constructed according to the invention.

FIG. 34 is a cross section of a stator wound with the conductor of FIG. 33.

### DETAILED DESCRIPTION OF THE INVENTION

In all figures showing preferred embodiments of the invention like elements are indicated with the same numeric designation.

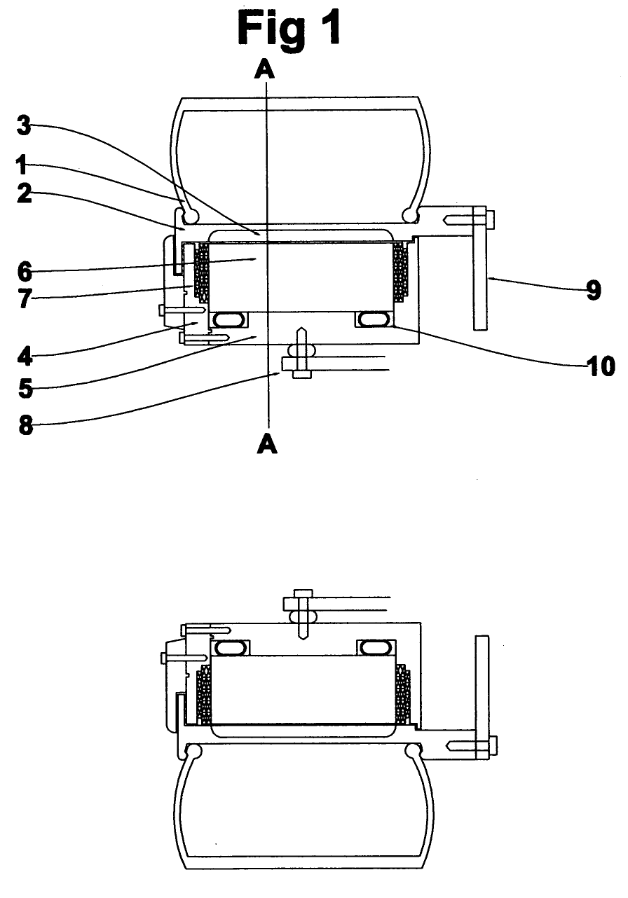

FIG. 1 is a section view of a dynamo electric machine implemented as a wheel motor for a motor vehicle constructed according to a first preferred embodiment of the invention. At 1 is designated a typical automobile tire mounted on a wheel constructed of high strength aluminum or other nonmagnetic but electrically conductive material 2 into which are embedded iron pole pieces 3. A stator body constructed in two parts 4 and 5 which are sized to clamp tightly a stack of iron laminates 6 is mounted to the vehicle by suspension members 8. Winding conductors 7 are wound onto toothed projections of the stator iron laminates. A brake disc 9 is mounted to special fittings formed onto the wheel. Coolant distribution and circulation is provided by dedicated coolant passages 10 which may communicate by flexible tubes not shown to a coolant management system mounted at any location on the vehicle.

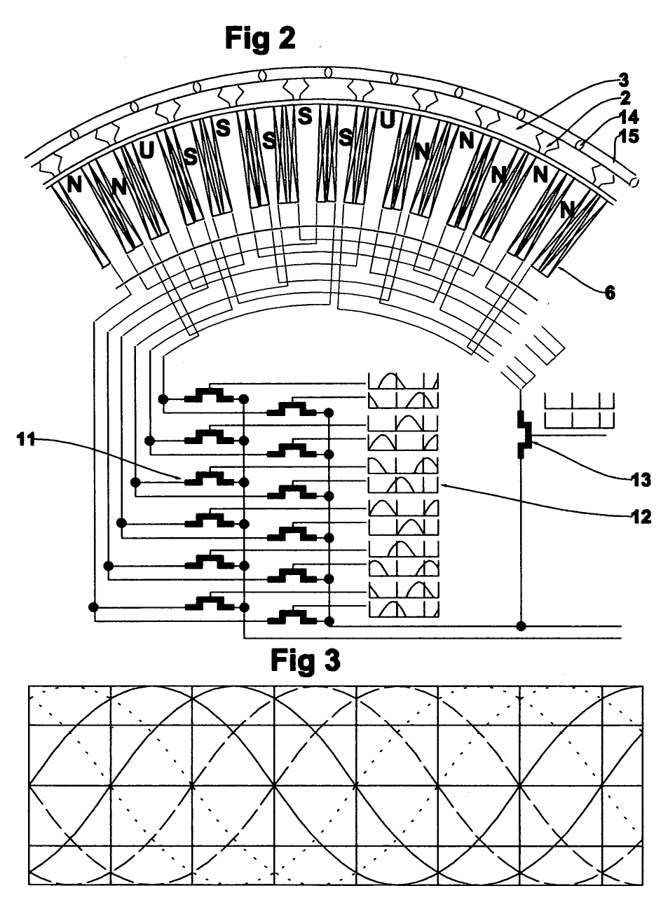

FIG. 2 is a longitudinal section of a segment of a dynamo electric machine constructed according to a first preferred embodiment of the invention, such as the motor of FIG. 1 at A-A. The rotor magnetic pole pieces 3 are formed into a single piece by the nonmagnetic electrically conductive structural material 2 which also acts as the inductive current conductors of the rotor when it is operating as an inductive machine. At 15 are indicated the moveable secondary rotor pole pieces which are formed into a single piece by nonmagnetic material 14. These pieces are designed so that in a first position as indicated they will create a magnetic path between adjacent rotor pole pieces which leaves the rotor suitable for operation in an induction machine, but they may be moved to a second position not illustrated here in which they leave each rotor pole piece magnetically isolated and suitable for operation in a synchrolous machine. Also in the figure are indicated the connections of the six phase windings and driver exciter waveforms when the motor operates as an induction machine. At 11 is indicated the six main driver pairs which power the main windings. The windings are Wye connected in two sets of three phase windings as indicated. Of course it would be likely that the stator 6 and stator windings would extend up to a full 360 degrees of motor circumference, though for illustration purposes only a 72.5 degree segment are shown in this drawing. At 12 is indicated one possible form of driver excitation waveforms indicating how the RMS gate power of the drivers is formed. It will be noted that the gate power waveforms of phases 4, 5, and 6 indicated as D, E, and F may be out of step with their respective phases 1, 2, and 3 gate power waveforms by a selected amount, in this case +60 electrical degrees which helps smooth the steps of the resulting rotating magnetic field set up by the stator. At 13 is indicated a seventh driver and its waveform connected between the Wye point of the second set of windings and the negative supply bus. When the motor is operating as an induction machine this driver is not excited, as indicated by the absence of any waveform associated with this driver.

FIG. 3 is a power waveform diagram showing 450 electrical degrees of the power applied to each of the six phases of the machine of FIG. 1 when it is operating as an induction motor. At the bottom of the diagram are phase letters which corespond to the phases indicated in FIG. 2 and which indicate which phase is then crossing the electrical zero voltage axis from negative to positive at that phase angle.

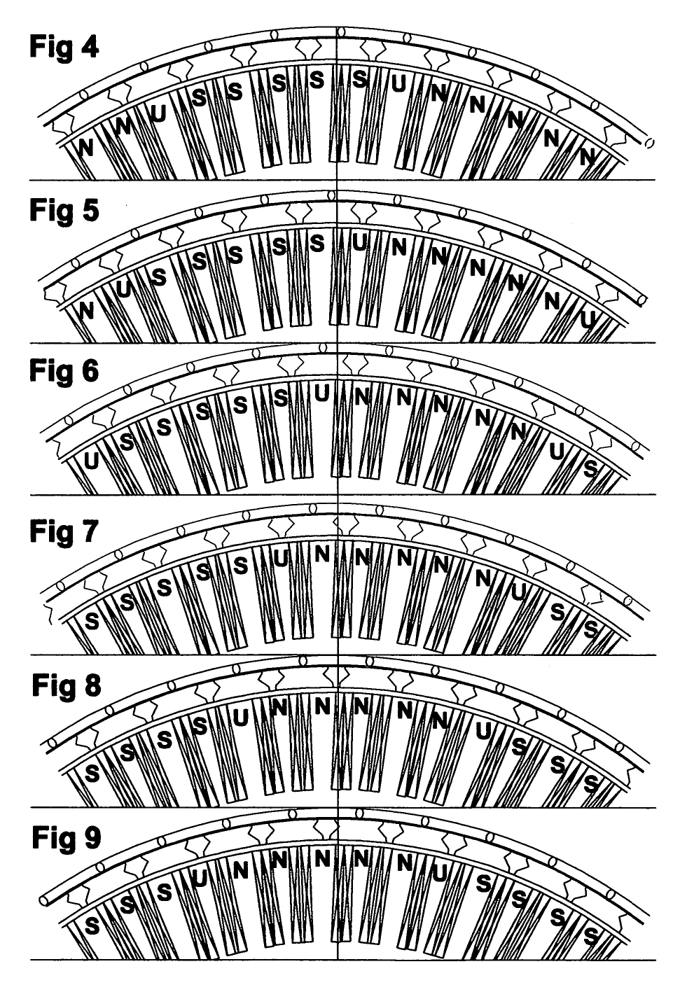

FIGS. 4 to 9 show the rotor movement at 60 electrical degree intervals of the motor in FIG. 1 when it is operating as an induction machine through 360 electrical degrees. The larger letters at the tops of the stator teeth indicate the magnetic polarity (N for North, S for South and U for Unexcited) of that end of the stator tooth when it is wound, connected and excited according to FIGS. 2 and 3. FIGS. 4 to 9 show the rotor position and tooth polarity at each of the 60 electrical degree intervals of a full 360 degrees of electrical excitation, during which period the rotating magnetic field of the stator moves through 30 mechanical degrees. In this same period the rotor is shown moving only 7.5 mechanical degrees indicating a 75% slip which results in large induced currents flowing in the induction circuit conductors of the rotor, The smaller letters at the midpoint of the stator teeth of FIG. 4 indicate which phase (A,B,C,D,E or F) is connected to that tooth and also indicates with an appended r which teeth have coils which are connected in reverse polarity. As anyone skilled in the art can discern the machine will work very effectively as an induction machine.

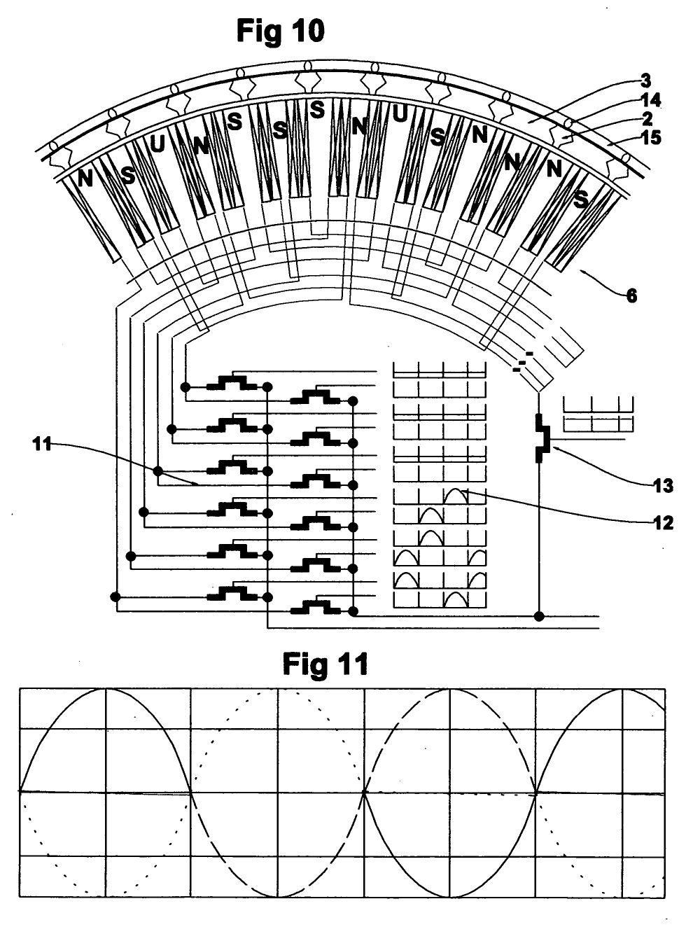

FIG. 10 is a longitudinal section of the motor of FIG. 1 indicating the connections of the windings and driver exciter waveforms when the motor operates as a synchronous machine. All parts of the drawing are the same as are indicated in FIG. 2. At 15 are indicated the moveable secondary rotor pole pieces which are formed into a single piece by nonmagnetic material 14. These pieces are in this instance shown moved to a second position in which they leave each rotor pole piece magnetically isolated and thus the rotor becomes suitable for operation as a rotor for a synchrolous machine. Also in the figure for reference are again indicated the connections of the six phase windings and driver exciter waveforms 12 when the motor operates as a synchronous machine. Note that here the drivers for phases D, E and F supply only a low fixed DC voltage to these phases, and that the driver 13 connected from the Wye point of phases D, E and F is active, providing a path for the resulting direct current to return to the power supply.

FIG. 11 is a power waveform diagram showing 450 electrical degrees of the power applied to the A, B and C phases of the machine of FIG. 1 when it is operating as a synchronous motor or of the power generated by the machine when it is operating as a synchronous generator. It can be noted here that the modified sinusoidal waveforn for each phase during a full 360 electrical degree cycle completes it's negative excursion in 120 electrical degrees, then it's positive excursion in the next 120 electrical degrees, then remains at zero for the final 120 electrical degrees.

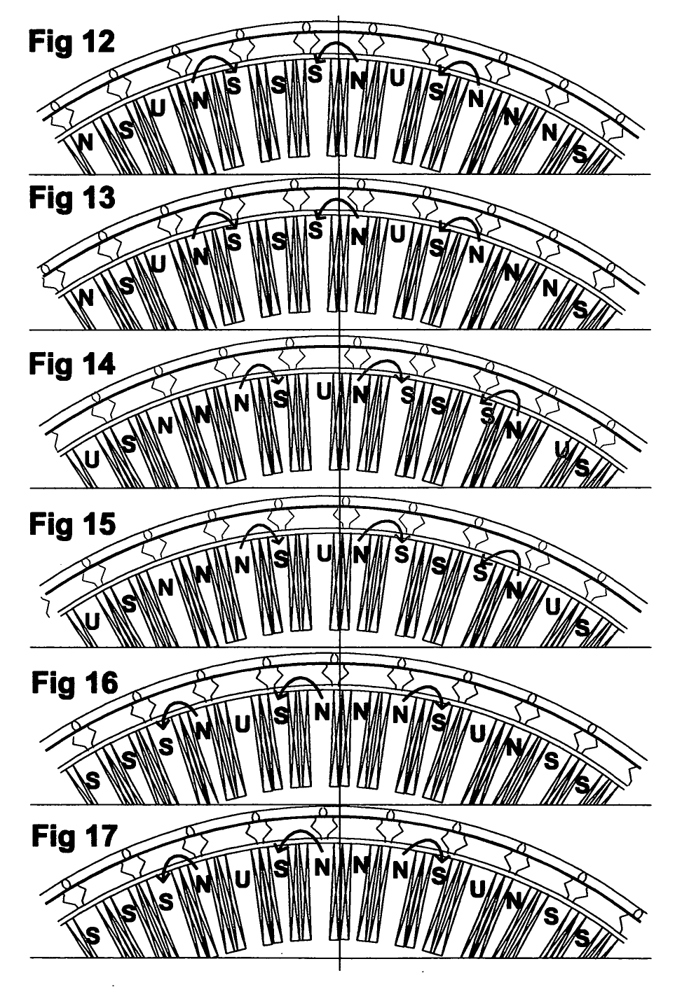

FIGS. 12 to 17 show the rotor movement at 60 electrical degree intervals of the motor in FIG. 1 when it is operating as a synchronous machine through 360 electrical degrees. Again the larger letters at the tops of the stator teeth indicate the polarity (N for North, S for South and U for Unexcited) of that end of the stator tooth when it is wound, connected and excited according to FIGS. 10 and 11 at each of the 60 electrical degree intervals of a full 360 degrees of electrical excitation, during which period the rotating magnetic field of the stator moves through 7.5 mechanical degrees. In this same period the rotor is shown also moving 7.5 mechanical degrees indicating a 0% slip or synchronous operation which results in no induced currents flowing in the induction circuit conductors of the rotor. The arrows indicate the paths of the magnetic lines of force induced by the stator for some of the stator teeth.

The electrical frequency for a given rate of magnetic field rotation of the stator is 4 times higher when it operates as an induction machine than when it operates as a synchronous machine, a feature which is beneficial to typical applications such as automotive drive wheels, since inductive operation is typically only used for acceleration from standstill at slow rates of rotation. At higher operating speeds the stator drivers can switch the machine to synchronous operation during which a given power frequency will provide four times the rate of rotation of the rotor than it would if the motor operated as an induction machine at that frequency, an operation which is quite comparable to that of a two-speed transmission.

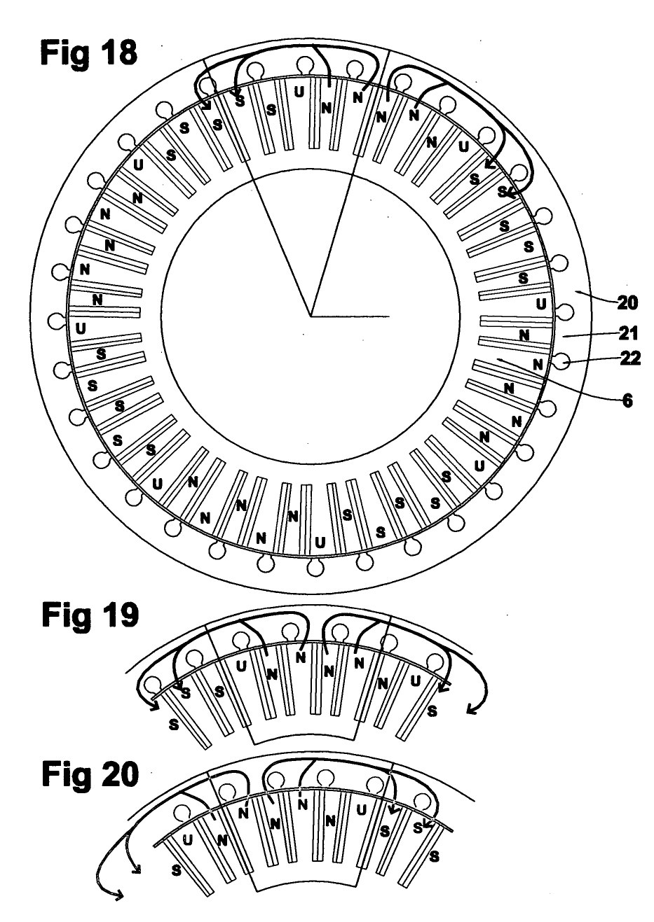

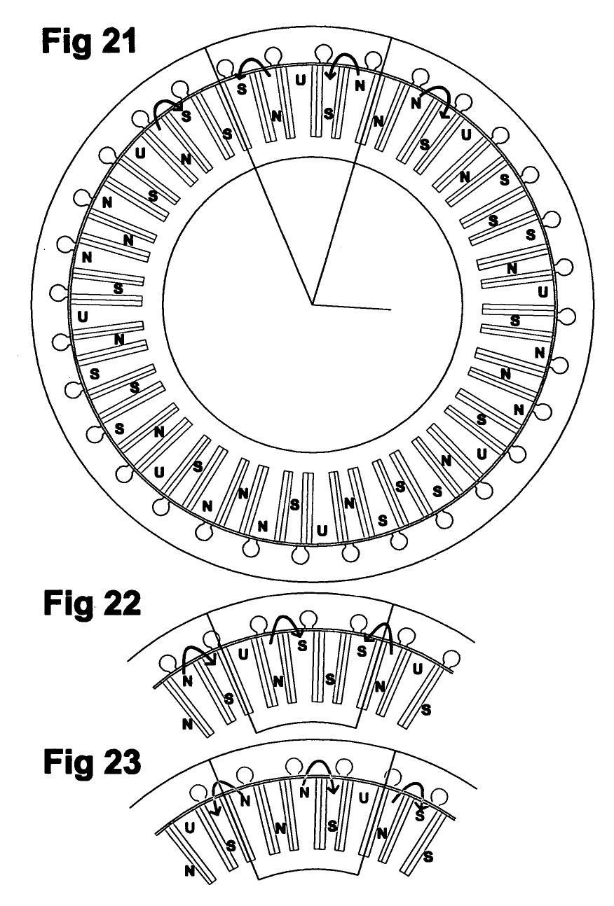

FIG. 13 shows in section the rotor 20 and stator 6 of a dynamo electrical machine constructed according to a second preferred embodiment of the invention and which is capable of operating as either an induction machine or as a synchronous machine. All aspects and features of the stator and its connections and driver circuit are the same as in FIGS. 2 and 3 and therefore detail has been omitted here. The only difference in this embodiment is that the rotor is not constructed to mechanically change configuration when the machine switches from inductive operation to synchronous operation. Instead the designer depends on a high rate of salience of the rotor teeth 21 which are surrounded by non-magnetic but electrically conductive material 22 to isolate individual rotor poles magnetically during synchronous operation, which is discussed in relation to FIG. 21 which illustrates the same machine in synchronous operation. Again each stator tooth is labeled with a letter to indicate the polarity (N for North, S for South and U for Unexcited) of that end of the stator tooth when it is wound, connected and excited according to FIGS. 2 and 3 Heavy arrows at the top of FIG. 18 illustrate the paths of some of the magnetic lines of force within the rotor during periods when the machine is operating as an inductive machine.

FIGS. 19 and 20 show the rotation of the a segment of the rotor of FIG. 18 at 120 and 240 electrical degree intervals. Again each stator tooth is labeled with a letter to indicate the polarity (N for North, S for South and U for Unexcited) of that end of the stator tooth when it is wound, connected and excited according to FIGS. 2 and 3. Heavy arrows at the top of FIGS. 19 and 20 illustrate the paths of some of the magnetic lines of force within the rotor during periods when the machine is operating as an inductive machine.

FIG. 21 shows the same rotor and stator from FIG. 18 when excited as a synchronous machine. Again each stator tooth is labeled with a letter to indicate the polarity (N for North, S for South and U for Unexcited) of that end of the stator tooth when it is wound, connected and excited according to FIGS. 10 and 11. Heavy arrows at the top of FIG. 21 illustrate the paths of some of the magnetic lines of force within the rotor during periods when the machine is operating as a synchronous machine. Note that there will be a tendancy for magnetic lines to leak around the rotor's inductive conductors and thus waste the energy spent to set them up expecially during periods of heavy excitation in synchronous mode when the magnetic paths are nearing saturation. For this reason the designer may consider employing specially high permitivity steels for rotor construction, and/or restricting synchronous operation to significantly lower rates of power than inductive operation especially for a machine constructed according to the invention with this type of rotor.

FIGS. 22 and 23 show the rotation of the rotor of FIG. 21 at 120 and 240 electrical degree intervals. Again each stator tooth is labeled with a letter to indicate the polarity (N for North, S for South and U for Unexcited) of that end of the stator tooth when it is wound, connected and excited according to

FIGS. 10 and 11 Heavy arrows at the top of FIGS. 19 and 20 illustrate the paths of some of the magnetic lines of force within the rotor during periods when the machine is operating as a synchronous machine.

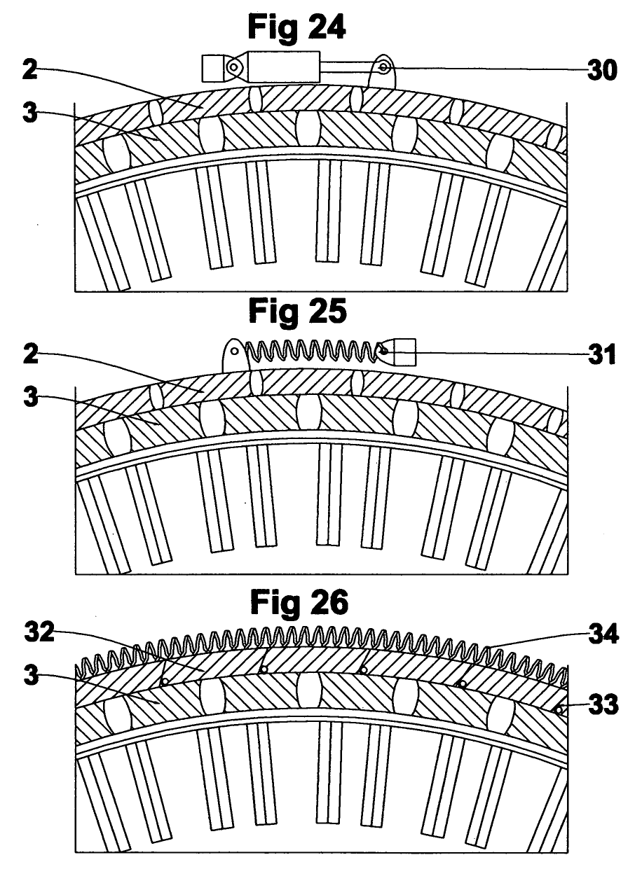

FIG. 24 shows a detail of the rotor of a second embodiment of the present invention having a single moveable means 2 of opening or closing the magnetic circuit between rotor pole pieces 3. In particular is illustrated an actuator 30 which adjusts the relative position of the moveable means with reference to the main rotor pole pieces.

FIG. 25 shows a third embodiment of the invention having a single moveable means 2 of opening or closing the magnetic circuit between adjacent rotor pole pieces 3 and a spring 31 which controls the relative position of the moveable means with reference to the main rotor pole pieces. A machine constructed according to this embodiment of the invention depends on the power of the rotating magnetic field of the stator when it is operating at high power ratings to overcome the spring 31 and to move the single moveable means 2 rotateably about the rotor to a position where the secondary pole pieces magnetically bridge the gaps between main rotor pole pieces 3. When the input power to the stator reduces for operation in synchronous mode, the spring 31 overcomes the rotating magnetic field's pull on the moveable means 2, allowing it to return the required few degrees until its secondary pole pieces no longer magnetically bridge the gaps between the main rotor pole pieces 3, leaving the rotor suitable for operation as a synchronous machine.

FIG. 26 shows a fourth embodiment of the invention having a large number of individually moveable means of opening the magnetic circuits 32 mounted on individual hinges 33 between rotor pole pieces 3 and also having a surrounding spring 34 which controls the position of the large number of hinged moveable magnetic pieces. This embodiment only works if the rotor is mounted around the outer circumference of the stator. When the rotor is turning at a low rate of speed, the spring 34 overcomes the centrifugal acceleration of the moveable magnetic pieces 32, which then lay flat against the backs of the main rotor pole pieces 3, thus closing the magnetic circuit between pole pieces leaving the rotor suitable for operation as a rotor in an induction machine. When the rotor is turning at a high rate of speed, the centrifugal acceleration of the moveable magnetic pieces 32 overcomes the spring 34, which then allows the moveable magnetic pieces to move on their hinges 33 away from the backs of the main rotor pole pieces 3, thus opening the magnetic circuit between pole pieces and leaving the rotor suitable for operation as a rotor in a synchronous machine.

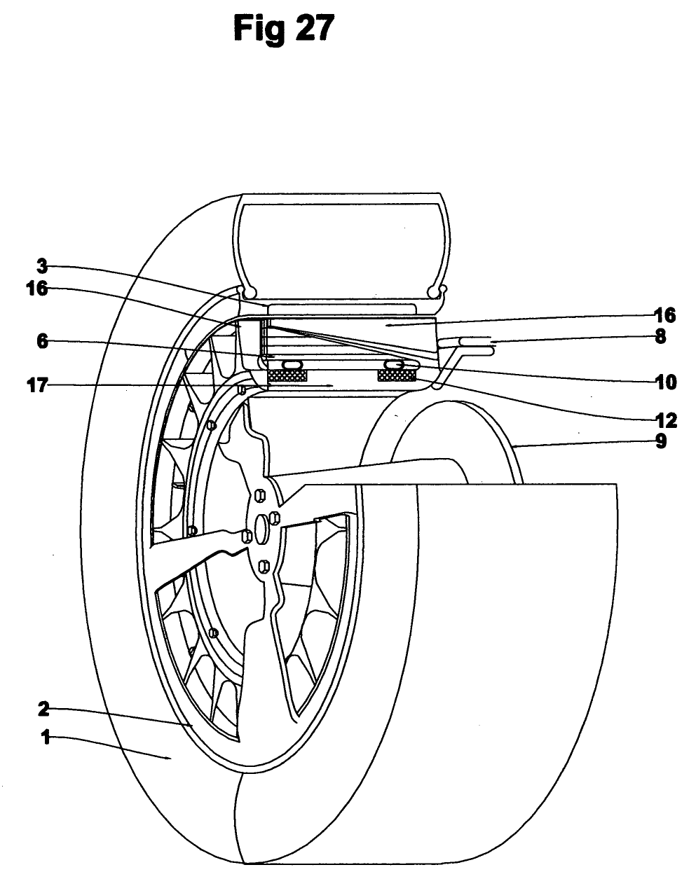

FIG. 27 shows a wheel motor constructed according a fifth embodiment of the invention having the exciter poles of the stator constructed as extended fingers 16 from alternate sides of a main exciter body 17 mounted to the back of the stator 6. An exciter coil 12 is wound bobin fashion and installed into the gap between the back of the stator and the exciter body along with coolant tubes 10. In this embodiment of the invention, the exciter poles and coil can not participate in operating the machine when in induction mode, instead simply remaining unexcited. Since there are no exciter teeth or windings on the stator of this embodiment, this construction provides more space in the main stator slots for installing the windings of the main stator teeth, and simplifies the construction of the exciter coil winding. The stator may simply remain open to be cooled by convection of forced air and/or thermal conduction to a cooling coil, or be fully enclosed and force cooled in a manner not shown.

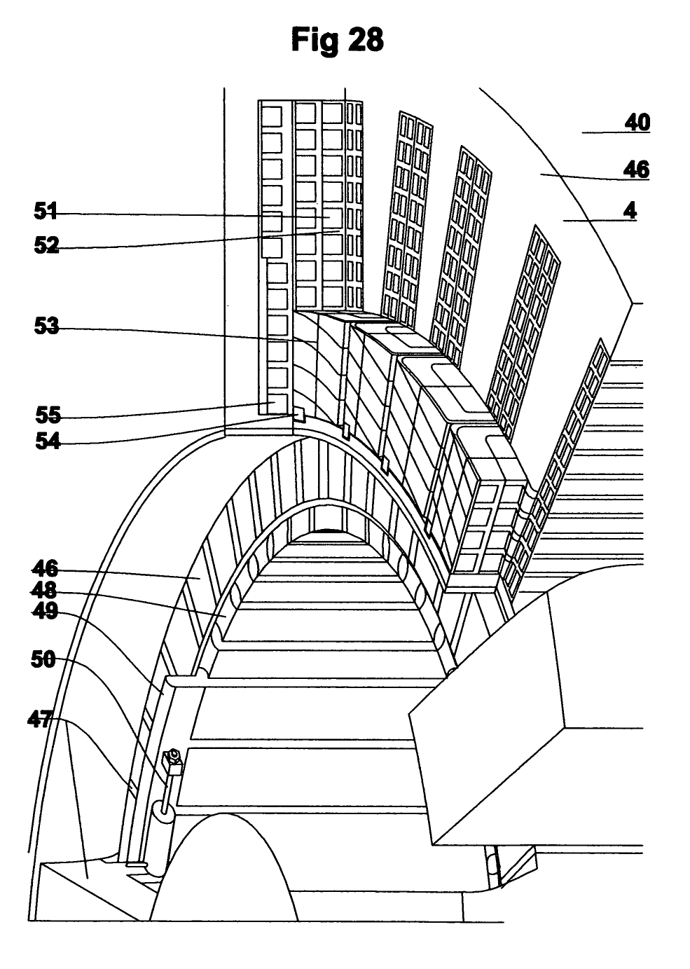

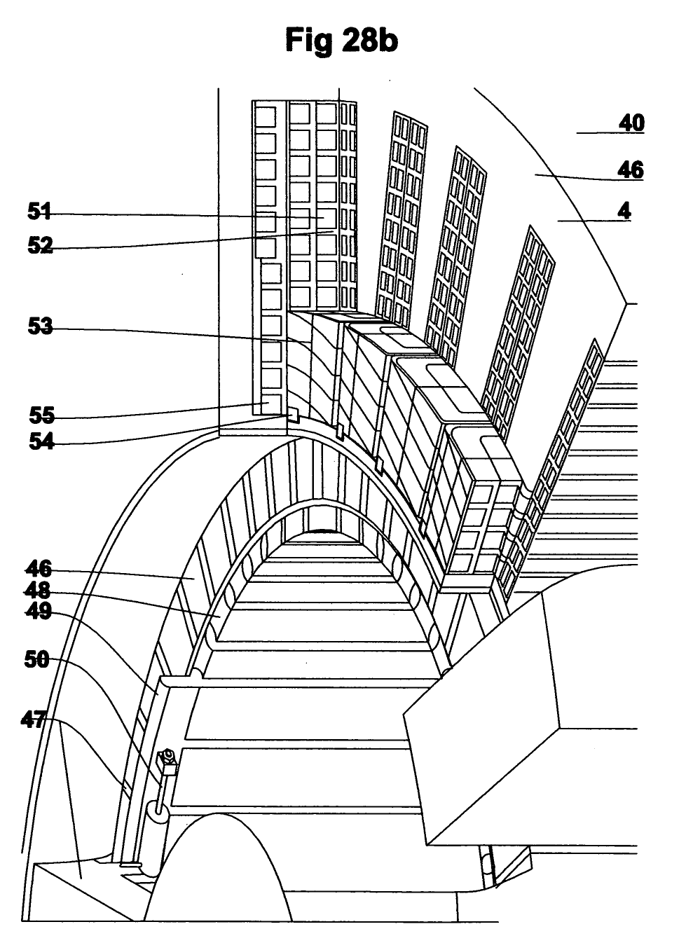

FIG. 28 shows a view in partial section of a dynamo electrical machine constructed according to a first preferred embodiment of the invention having the conductors of the stator windings surrounded in an open cell foam material. A stator 40 is attached by mounting blocks 41 and bolts 42 to the front of a typical automobile piston engine 43. A rotor 44 is attached to the crankshaft 45 of the engine. In this figure, part of the stator is shown cut away to more clearly display the internal construction of the machine, particularly the stator windings and insulation system.

FIG. 28b is a detail of a part of the stator windings and rotor of the dynamo electrical machine of FIG. 28. The rotor consists of individual main pole pieces 46 of a magnetic material embedded into an electrically conductive non-magnetic material 47 which is formed to create the rotor structure. A secondary set of individual magnetic pole pieces 48 are formed into a single moveable piece by non-magnetic material 49 which is installed so that it can be rotated between a first position and a second position within the rotor by an actuating means 50. In the first position, as shown, the secondary pole pieces close a magnetic circuit between each of the main pole pieces, leaving the rotor suitable for operation in an inductive machine such as would be effective for use as a starting motor for the engine. In the second position, not shown, the secondary pole pieces are moved by the said actuator means until the magnetic circuit between each of the main pole pieces is open, leaving the rotor suitable for operation in a synchronous machine, as would be suitable for generating electricity for auxiliary power or hybrid drive circuitry for the automobile. The slot windings of the stator are comprised of bare or thinly insulated conductors 51 laid into grooves formed into preformed rigid open cell foam blocks 52. In this embodiment, the preformed foam blocks are created to surround one half of one stator tooth, meeting at a convenient point on the stator tooth as indicated at 53. Each layer of the winding of a stator tooth uses blocks shaped and formed to suit that particular layer. The said foam blocks and possibly the stator base material have special passages 54 preformed into them to enable each end of the coils to be brought out for connection by thermit welding, brazing or other suitable means at 55. In this manner, short bursts of very high electrical power input and therefore torque can be sustained without damage during cold starts by a relatively small stator which would then make an efficient synchronous generator for the engine.

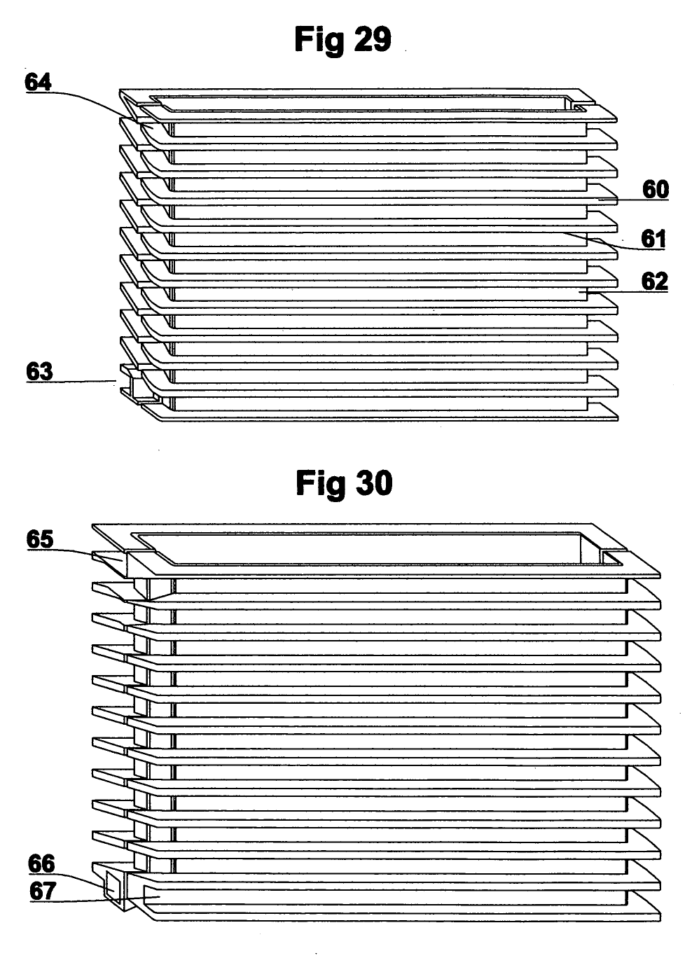

FIG. 29 is a view of the preformed slot winding insulation elements which form the two halves of a coils first layer of windings in the dynamo electrical machine of FIG. 27. The one-piece block of open cell foam insulating material is comprised of a base material 62 and raised ridges 60 and 61 which completely enforce separation of each turn of the conductor. Provision is made at 64 to change position at each new turn, and at 63 to pass the starting tail of the conductor out from the base of the coil for connection after the coil is installed into the machine. In a first preferred embodiment of the invention, the foam material is comprised of an open cell silicon carbide foam fabricated by expanding a carbon pitch base material into a foam which fills an appropriate mould in an environmentally controlled furnace. The resulting formed foam material is then, if necessary machined or shaped to final form, then further treated by partially or fully graphitizing the foam material and/or concurrently or sequentially converting the carbon into silicon carbide by treating it in a furnace blanketed with silane gas by any of the several currently well-known method until the desired combination of material properties for a particular coil winding application are achieved, including electrical resistivity, thermal conductivity and mechanical strength. It should be understood that this insulation technique for coil windings of electrical machines can be applied to a very wide range of electrical machines and that this embodiment is illustrative only. Other materials may be used to create the open cell foam parts, the foam may be preformed in a variety of ways in addition to the two coil half parts illustrated here, the foam material may be placed into the slots after completion of the winding operation in a process comparable to current impregnation steps, or the foam may be pre-applied to the conductors prior to installing the conductors into the stator slots.

FIG. 30 is a view of the preformed slot winding insulation elements which form the halves of a coils second layer of windings in the dynamo electrical machine of FIG. 27. The conductor tail from the previous layer enters at 65, is wound sequentially into the provided grooves until exiting either to another layer, or for connection, at 67. Provision is made at 66 to pass the other end of the conductor from the previous layer out for connection. Persons skilled in the art will see immediately that the invention can be used not only for the coils of a dynamo electrical machine, but also for other purposes for which high performance magnetic coils may be useful, including but not limited to transformers, magnetic solenoids etc. Calculations indicate that using these techniques an induction motor can be constructed to fit within the wheel of a standard automobile tire which would be capable of accepting short bursts of power up to 100 kilowatts when wound with a conductor of cross section equivalent to 16 awg. If an active cooling means is then provided the sole limitation on the length of time which the motor could withstand such power application would be the thermal limit of the rotor magnetic material which is somewhat more difficult to actively cool. Of course, active cooling can also mitigate the increases of resistance of the conductors at high temperatures, a feature which would improve the motor's efficiency.

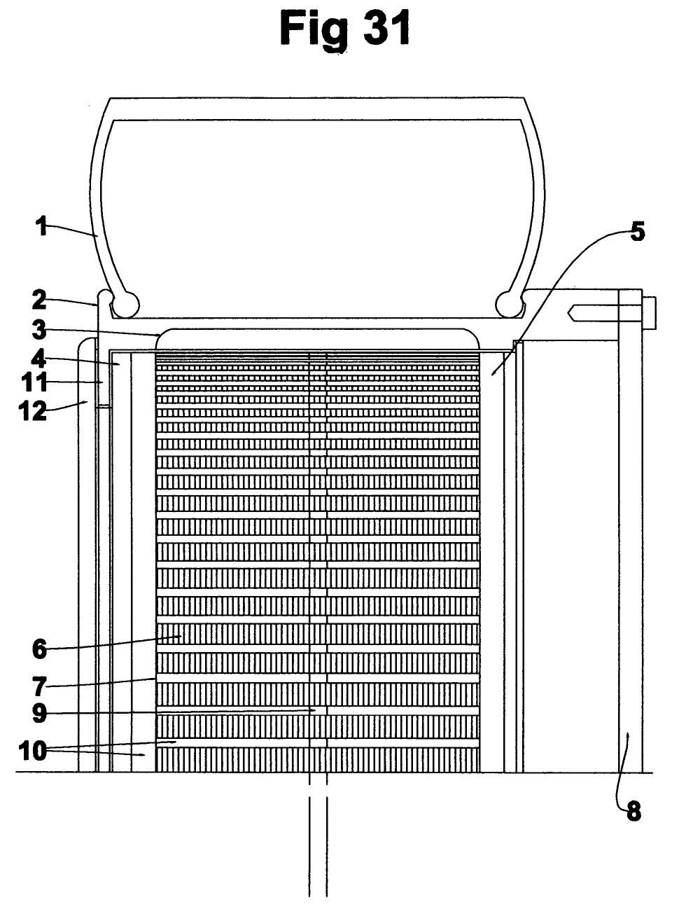

FIG. 31 is a view of one half of the stator outer surface of a dynamo electrical machine constructed according to the invention in which the stator/rotor gap acts as a gas bearing to support the rotor surface during rotation In the application of the invention illustrated here, an automobile tire 1 is mounted on a wheel constructed of high strength aluminum or other nonmagnetic but electrically conductive material 2 into which are embedded iron pole pieces or a set of laminates 3. A stator body constructed in two parts 4 and 5 which are sized to clamp tightly a stack of steel stator laminates 6 is mounted to the vehicle by suspension members not shown. Winding conductors are wound into slots 7 between toothed projections 6 of the stator iron laminates. A brake disc 8 is mounted to special fitting formed onto the wheel. Coolant distribution and circulation is provided by dedicated coolant passages which supply coolant from flexible tubes and a coolant management system mounted at any location on the vehicle (not shown) The coolant is supplied at relatively higher pressure to a point near the bottom of the stator from which it permeates the open cell foam insulation of the stator winding conductors. From there part of the coolant flow exits the stator into the stator-rotor gap via openings 9 provided in the non-magnetic gap closing material 10 All the exposed tops of the winding slots which comminucate with the stator-rotor gap are closed off to coolant circulation into the gap except the small openings 9 indicated, which are designed to provide only just the correct amount of flow at the correct pressure to operate the system as a gas bearing at its rated load. If the coolant gas is air it may simply be allowed to leak at a low rate from the sides of the rotor-stator gap. If the coolant is one which needs to be entirely recirculated, such as a refrigerant or CO2, then a sealing means such as a contact graphite or ceramic seal is provided at the edges of the stator-rotor gap. The gas bearing may also be constructed to provide a thrust bearing capability by installing a disk such as at 11 which operates at gas bearing clearances from stator elements 4 and 12. The flow of the coolant between the inlet and the outlet of the stator is then managed by a control system which allows the gas bearing to always recieve the correct gas pressure for its function regardless of the stator coolant inlet and outlet pressure differences. The lower parts of the stator may also be divided into segments with coolant flow limiters or barriers (not shown) installed at the sides of the stator to enable varying the coolant pressure for various modes of operation, such as bottom ¼ at high pressure for cruising, bottom ¼ and rear ¼ at high pressure for acceleration, and bottom ¼ and front ¼ at high pressure for braking.

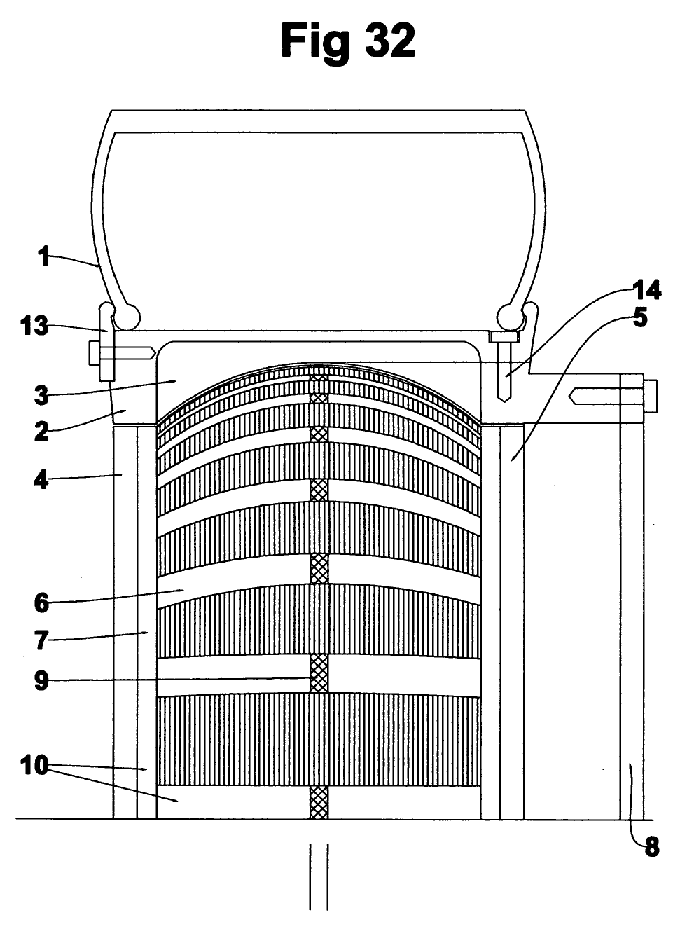

FIG. 32 is a view of one half of the stator outer surface of a second dynamo electrical machine constructed according to the invention in which the stator/rotor gap acts as a gas bearing to support the rotor surface during rotation and the shape of the stator-rotor gap is modified to allow it to act as an axial thrust bearing as well as a radial load bearing. All is the same as in FIG. 31 except the stator-rotor gap is given an arc shaped surface in its longitudinal direction which allows the resulting gas bearing to provide both radial load support to the rotor and axial thrust support to the rotor. Of course, given the difficulty of dismounting the wheel in this configuration a part of the wheel rim 13 may be made separately removeably to facilitate changing of tires when necessary. Also, to enable assembly of this wheel motor the rotor may need to be constructed in two parts held together by bolts 14 as indicated, or other means to enable assembly may work as well or better.

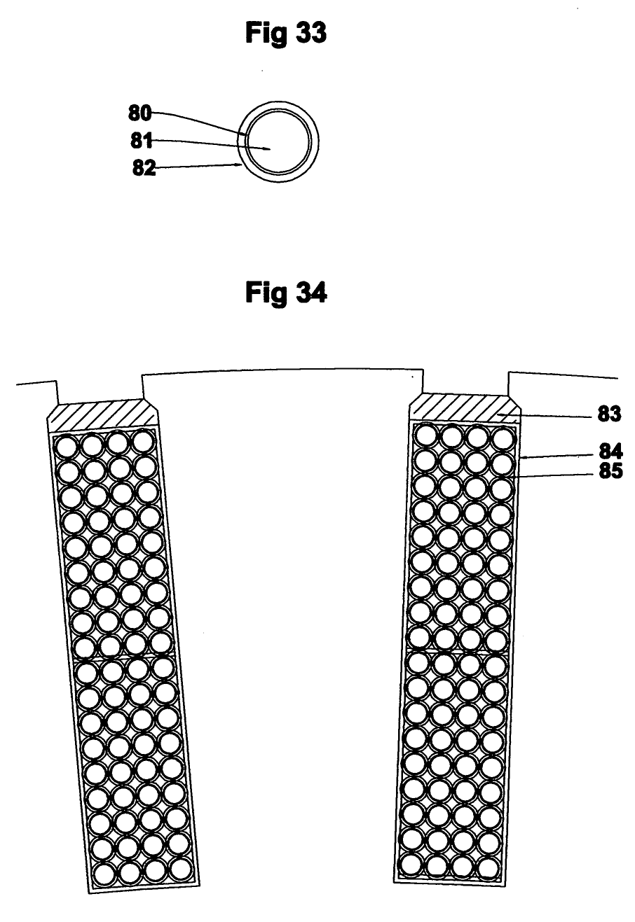

FIG. 33 is a cross section view of a PPS (polyphenelyne sulfide) or enamel 80 insulated conductor 81 which is coated prior to winding with a layer of open cell foam material 82 for use in winding an electrical machine. In this example the foam material is applied to a coating thickness so that the cross sectional area of the foam material equals the cross sectional area of the coated conductor, with the goal of achieving approximately a 50% slot fill with the conductor material. The open cell foam material may be a somewhat deformable material to the purpose of fixing the conductors in place in the slots by the contact pressure among the conductors. In this manner the manufacturer may avoid having to impregnate the winding with varnish or epoxy, a process which would of course defeat the aim of providing passages through the open cell foam coating of the conductors for a coolant fluid, either liquid or gas.

FIG. 34 is a cross section of a stator wound with the conductor of FIG. 33. The conductors are tightly fixed into place between the slot insulating material 84 by slot wedge 83, with the result that the winding does not need to be varnish or epoxy impregnated, leaving passages 85 both through the open cell structure of the foam coating and in the open spaces created by the round cross section of the conductor coating, for coolant to flow within the winding. The result is a machine which can safely handle higher loads for a given conductor cross section without reaching a temperature which could damage the conductor insulation, even with just forced ambient air as the coolant. Of course more effective coolant systems will allow greater electrical loads on the conductors.

Those skilled in the art who now have the benefit of the present disclosure will appreciate that the present invention may take many forms and embodiments and have many uses. For example, the present invention can be used on motors with standard construction, eg. pure inductive machines, as well as superconductor wound machines, or transformers or other machines. It is intended that the embodiments described herein should be illustrative only, and not limiting of the present invention. Rather, it is intended that the invention cover all modifications, equivalents and alternatives falling within the spirit and scope of the invention as defined by the appended claims.

1) A dynamo electric machine constructed by
i) linking the peripheral portions which are disposed furthest from the rotor face of a plurality of armature teeth arranged at equiangular pitches in a circumferential direction by an annular core body; and
ii) winding around the teeth a plurality of coils composed partly of coils that are always excited by alternating current and partly of coils that are excited first by alternating current during a period of high torque demand induction machine operation and second by direct current during a period of lower torque demand operation as a synchronous machine:
iii) molding, forging, casting, machining or otherwise shaping a non-magnetic material into the shape of a round rotating member or rotor, which will fit closely inside, outside or longitudinally proximate the said stator and
having all or part of the non-magnetic material of which the part of the rotor nearest the stator is composed and which magnetically isolates the rotor poles from one another be a nonmagnetic material which is also electrically conductive to facilitate circulation of inductive currents induced by the stator magnetic field during a period of higher torque demand operation as an inductive machine.

2) A dynamo-electric machine according to claim 1, wherein a plurality of separately formed magnetic poles composed of magnetic members arranged at equi-angular pitches in the circumferential direction are embedded into the central base portion which is nearest the stator of the said rotor the magnetic poles being formed into one piece by the base portion

3) A dynamo-electric machine according to claim 2, wherein a ratio of a number of the teeth on the itator and a number of the magnetic poles installed into the rotor is [2×synchronous mode phase count]/[synchronous mode phase count+1].

4) A dynamo-electric machine according to claim 3 which is capable of operating as an induction machine or as a synchronous machine and the phase count of the machine while operating in induction mode may he either equal to or double the phase count ofthe machine while operating in synchronous mode

5) A dynamoelectric machine according to claim 4, wherein the base portion of the rotor into which the separately formed magnetic poles are embedded
does not cover the face of the poles which is furthest from the stator, thus leaving that face exposed so a moveable magnetic material may contact said faces to complete a magnetic circuit within the rotor during periods when said rotor is operating as an induction machine, then by moving, magnetically isolate each magnetic pole from the others during periods when said rotor is operating as a synchronous machine.

6) A dynamoelectric machine according to claim 5, wherein the moveable magnetic material is comprised of a second set of magnetic pieces of similar dimensions and construction to the poles and which are embedded into a second base portion which is non-magnetic but electrically nonconductive, and which forms the said pieces into a single member which is rotatably moveable by an actuator or by the magnetic forces of the said stator in conjunction with a spring means about the axis of the rotor between 2 positions; being
a first position which causes the pieces to bridge the magnetic gap between the first set of magnetic pieces, leaving the poles suitable for operation as an induction machine; and
a second position which causes the pieces to break the magnetic continuity between the first set of magnetic pieces, leaving the poles suitable for operation as a synchronous machine.

7) A dynamoelectric machine according to claim 5, wherein the moveable magnetic material is comprised of a set of magnetic pieces which are attached by hinges to the face of the rotor which is furthest from the stator teeth; and
which said pieces are of suitable dimensions and construction that when the pieces lie flat against the back faces of the poles they complete a magnetic circuit between adjacent poles making the poles suitable for operation as an induction machine and;
when the pieces move on the said hinges away from the backs of the poles the magnetic circuit between poles is broken, leaving the poles suitable for operation as a synchronous machine.

8) A dynamrelectric machine according to claim 7, where the stator is fixed at the center of a rotor which moves rotatably about the outer circumference of the said stator and; the said hinged pieces are held against the furthest outer surface of the rotor by one or more springs which are selected so that
when the said rotor turns slowly the springs overcome the momentum of the pieces, causing them to lay flat against the backs of the poles thus completing the magnetic circuit between adjacent poles; and
when the said rotor turns quickly the momentum of the pieces overcomes the springs, causing them to move on the said hinges away from the backs of the poles, thus breaking the magnetic circuit between adjacent poles.

9) A dynamo-electric machine according to claim 1, wherein a plurality of magnetically joined magnetic poles comprised of salient magnetic members projecting from a core body are arranged at equi-angular pitches in the circumferential direction and are partially or fully surrounded at the salient portion which is nearest the stator of the said rotor by non-magnetic material which is also electrically conductive and the primary function of which is to facilitate passage of inductive currents induced by the stator magnetic field during periods of higher torque operation as an inductive machine.

10) A dynamo-electric machine according to claim 9, wherein a ratio of a number of the teeth on the stator and a number of the salient magnetic poles projecting from the rotor core body is [2×synchronous mode phase count]/synchronous mode phase count+1].

11) A dynamo-electric machine according to claim 10 which is capable of operating as an induction machine or as a synchronous machine and the phase count of the machine while operating in induction mode may be either equal to or double the phase count of the machine while operating in synchronous mode.

12) A dynamo electric machine constructed by
i) linking the peripheral portions which are disposed furthest from the rotor face of a plurality of armature teeth arranged at equiangular pitches in a circumferential direction by an annular core body; and
ii) winding around the teeth a plurality of coils composed solely of coils that are excited by alternating current
iii) installing an exciter pole member comprised of
1 a circumferential band of either inherently magnetized material or of easily electrically magnetizable material disposed radially from the annular core at an intervening distance sufficient to provide magnetic separation therefrom but physically attached thereto.
2 a plurality of teeth equal in number to the armature teeth and projecting alternately from opposite sides of the circumferential band, the teeth shaped so that each one projects axially outward, then back between the armature teeth alternately from one side, then from the other side
3 a field coil wound in bobbin fashion proximate to the circumferential band of magnetic material n a manner such that a direct current flowing in the coil will cause the teeth projecting from one side of the band to become magnetized as north magnetic poles, and the teeth projecting from the other side of the band to become magnetized as south magnetic poles
iii) molding forging, casting, machining or otherwise shaping a non-magnetic material into the shape of a round rotating member or rotor, which will fit closely inside, outside or longitudinally proximate the said stator and
having all or part of the non-magnetic material of which the part of the rotor nearest the stator is composed be a non-magnetic material which is also electrically conductive to facilitate passage of inductive currents induced by the stator magnetic field.

13) A dynamo-electric machine according to claim 12, wherein a plurality of separately formed magnetic poles composed of magnetic members arranged at equi-angular pitches in the circumferential direction are embedded into the central base portion which is nearest the stator of the said rotor each of the magnetic poles being formed into one piece by the base portion

14) A dynamo-electric machine according to claim 13, wherein a ratio of a number of the teeth on the stator and a number of the magnetic poles installed into the rotor is [1×synchronous mode phase count]/synchronous mode phase count+1].

15) A dynamo-electric machine according to claim 14, wherein the base portion of the rotor into which the separately formed magnetic poles are embedded
does not cover the face of the poles which is furthest from the stator, thus leaving that face exposed so a moveable magnetic material may contact said faces to complete a magnetic circuit within the rotor during periods when said rotor is operating as an induction machine, then by moving, magnetically isolate each magnetic pole from the others during periods when said rotor is operating as a synchronous machine.

16) A dynamo-electric machine according to claim 15, wherein the moveable magnetic material is comprised of a second set of magnetic pieces of similar dimensions and construction to the said poles and which are embedded into a second base portion which is non-magnetic, and which forms the said pieces into a single member which is rotatably moveable by an actuator or other means about the axis of the rotor between 2 positions; being
a first position which causes the pieces to bridge the magnetic gap between the first set of magnetic pieces leaving the poles suitable for operation as an induction machine; and
a second position which causes the pieces to break the magnetic continuity between the first set of magnetic pole pieces, leaving the poles suitable for operation as a synchronous machine.

17) A dynamo-electric machine according to claim 15, wherein the moveable magnetic material is comprised of a set of magnetic pieces which are attached by hinges to the face of the rotor which is furthest from the stator teeth; and
which said pieces are of suitable dimensions and construction that when the pieces lie flat against the back faces of the poles which is furthest from the stator they complete a magnetic circuit making the poles suitable for operation as an induction machine and;
when the pieces move on the said hinges away from the backs of the poles the magnetic circuit between poles is broken, leaving the poles suitable for operation as a synchronous machine.

18) A dynamo-electric machine according to claim 17, where the stator is fixed at the center of a rotor which moves rotatable about the outer circumference of the said stator and; the said hinged pieces are held against the furthest outer surface of the rotor by one or more springs which are selected so that
when the said rotor turns slowly the springs overcome the momentum of the said hinged pieces, causing them to lay flat, thus completing a magnetic circuit between adjacent poles and leaving the rotor suitable for operation as an induction machine; and
when the said rotor turns quickly the momentum of the pieces overcomes the springs, causing the said hinged pieces to move on the said hinges away from the backs of the poles, thus breaking the magnetic circuit and leaving the rotor suitable for operation as a synchronous machine.

19) A dynamo-electric machine according to claim 12, wherein a plurality of magnetically joined magnetic poles comprised of salient magnetic members projecting from a core body
are arranged at equi-angular pitches in the circumferential direction and are partially or fully surrounded at the salient portion which is nearest the stator of the said rotor by non-magnetic material which is also electrically conductive and the primary function of which is to facilitate passage of inductive currents induced by the stator magnetic field during periods of higher torque operation as an inductively excited machine

20) A dynamo-electric machine according to claim 19, wherein a ratio of a number of the teeth on the stator and a number of the salient magnetic poles projecting from the rotor is [1×synchronous mode phase count]/[synchronous mode phase count+1].

21) An electric machine having the individual turns of the coil windings of the machine separated from one another by an electrically non-conductive open-cell foam or other porous material so disposed as to enforce or assist electrical isolation of the said coil turns by physical separation while providing passage for a coolant fluid either liquid or gas to circulate through the coil winding insulation and
the said foam or other porous material is comprised of one or more materials selected from the list of silicon carbide, ceramic sol-gel, carbon, graphite, polyphenelyne sulfide, concrete, silica based areogel, polyurethane, polyethelyne, polyether, polyester, neoprene, melamine, natural rubber butyl rubber

22) A dynamo-electric machine as in claim 21 having the stator installed in an hermetic or semi-hermetic sealed container which is designed to contain an electrically non-conductive coolant fluid liquid or gas in a manner such that the said coolant permeates the pores of the said open cell foam material which separates the said individual turns of the coil windings of the stator.

23) A dynamo-electric machine as in claim 21 having the stator installed in an open enclosure which is designed to enable sufficient flow of air as coolant fluid in a manner such that the said coolant permeates the pores of the said open cell foam material which separates the said individual turns of the coil windings of the stator to the purpose of cooling the said stator.

24) A dynamo electric machine as in claim 21 having the stator outer surface only partly sealed to contain a pressurized coolant fluid liquid or gas and with openings being left in the said outer surface of the stator in a manner sufficient to allow the stator coolant fluid to occupy the gap between the stator and the rotor in a manner such that the said coolant fluid acts as the lubricant between the surfaces of the stator and the rotor which thus act as a bearing to support the rotor rotatably with minimal friction.

25) An electric machine as in claim 21 in which the foam or porous material is applied to the conductors which comprise the winding prior to the installation of the conductors into the winding.
